(19) United States
(12) Patent Application Publication
(10) Pub. No.: US 2021/0053552 A1
(43) Pub. Date: Feb. 25, 2021

(54) HILL DESCENT CONTROL SYSTEM FOR A HYBRID/ELECTRIC VEHICLE

(71) Applicant: FORD GLOBAL TECHNOLOGIES, LLC, Dearborn, MI (US)

(72) Inventor: Alex Szczepaniak, Ann Arbor, MI (US)

(21) Appl. No.: 16/545,111

(22) Filed: Aug. 20, 2019

(51) Int. Cl. B60W 20/14; B60W 30/18; B60W 10/18; B60W 10/26; B60W 10/04; B60W 10/10

(52) U.S. Cl. CPC B60W 20/14; B60W 30/18127; B60W 10/18; B60W 10/26; B60W 10/04; B60W 10/10; B60W 2720/10; B60W 2540/10; B60W 2510/244; B60W 2510/18; B60W 2520/10; B60W 2710/182; B60W 2550/142

(57) ABSTRACT

A regenerative braking control method for a vehicle includes releasing an accelerator pedal at a desired vehicle speed; detecting a subsequent increase in vehicle speed from the desired vehicle speed while the accelerator pedal is released; in response to detecting the subsequent increase in vehicle speed, increasing a regenerative braking torque to decrease vehicle speed and drive vehicle speed toward the desired vehicle speed; and in response to a next engagement of the accelerator pedal after the releasing the accelerator pedal, suspending regenerative braking torque and controlling vehicle speed based on a position of the accelerator pedal.

### TECHNICAL FIELD

The present disclosure relates to hybrid electric vehicles and control systems for hybrid/electric vehicles.

### BACKGROUND

Hybrid/electric vehicles may include an electric machine such an electric motor/generator that is configured to recharge a battery during regenerative braking.

### SUMMARY

A vehicle includes an electric machine, an automatic transmission, and a controller. The electric machine is configured to recharge a battery and to slow the vehicle via regenerative braking. The automatic transmission is disposed between the electric machine and at least one drive wheel. The automatic transmission is configured to shift between a plurality of gears. The controller is programmed to, in response to release of an accelerator pedal at a first vehicle speed and a subsequent increase in vehicle speed while the accelerator pedal is released, increase a regenerative braking torque to decrease vehicle speed and drive vehicle speed toward a desired vehicle speed. The controller is further programmed to, in response to vehicle speed decreasing to the desired vehicle speed via regenerative braking after the subsequent increase in vehicle speed, control regenerative braking torque to maintain vehicle speed at the desired vehicle speed. The controller is further programmed to, in response to regenerative braking torque reaching a maximum value and vehicle speed being greater than the desired vehicle speed after the subsequent increase in vehicle speed, downshift the transmission to decrease vehicle speed and drive vehicle speed toward the desired vehicle speed. The controller is further programmed to, in response to a state of charge of the battery exceeding a limit and vehicle speed being greater than the desired vehicle speed after the subsequent increase in vehicle speed, downshift the transmission to decrease vehicle speed and drive vehicle speed toward the desired vehicle speed. The controller is further programmed to, in response to a next engagement of the accelerator pedal after the release of the accelerator pedal, suspend regenerative braking torque and control vehicle speed based on a position of the accelerator pedal.

A vehicle includes an electric machine and a controller. The electric machine is configured to slow the vehicle via regenerative braking. The controller is programmed to, in response to release of an accelerator pedal at a first vehicle speed and a subsequent increase in vehicle speed while the accelerator pedal is released, increase a regenerative braking torque to decrease vehicle speed and drive vehicle speed toward a desired vehicle speed. The controller is further programmed to, in response to a next engagement of the accelerator pedal after the release of the accelerator pedal, suspend regenerative braking torque and control vehicle speed based on a position of the accelerator pedal.

A regenerative braking control method for a vehicle includes releasing an accelerator pedal at a desired vehicle speed; detecting a subsequent increase in vehicle speed from the desired vehicle speed while the accelerator pedal is released; in response to detecting the subsequent increase in vehicle speed, increasing a regenerative braking torque to decrease vehicle speed and drive vehicle speed toward the desired vehicle speed; and in response to a next engagement of the accelerator pedal after the releasing the accelerator pedal, suspending regenerative braking torque and controlling vehicle speed based on a position of the accelerator pedal.

### BRIEF DESCRIPTION OF THE DRAWINGS

FIG. 1 is a schematic illustration of an exemplary powertrain of a hybrid/electric vehicle;

FIG. 2 represents a flowchart illustrating a method of controlling an automatic transmission and regenerative braking in a hybrid or electric vehicle during a hill descent; and

FIG. 3 is a flowchart illustrating a method of further controlling the automatic transmission and regenerative braking in a hybrid or electric vehicle during a hill descent.

### DETAILED DESCRIPTION

Embodiments of the present disclosure are described herein. It is to be understood, however, that the disclosed embodiments are merely examples and other embodiments may take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

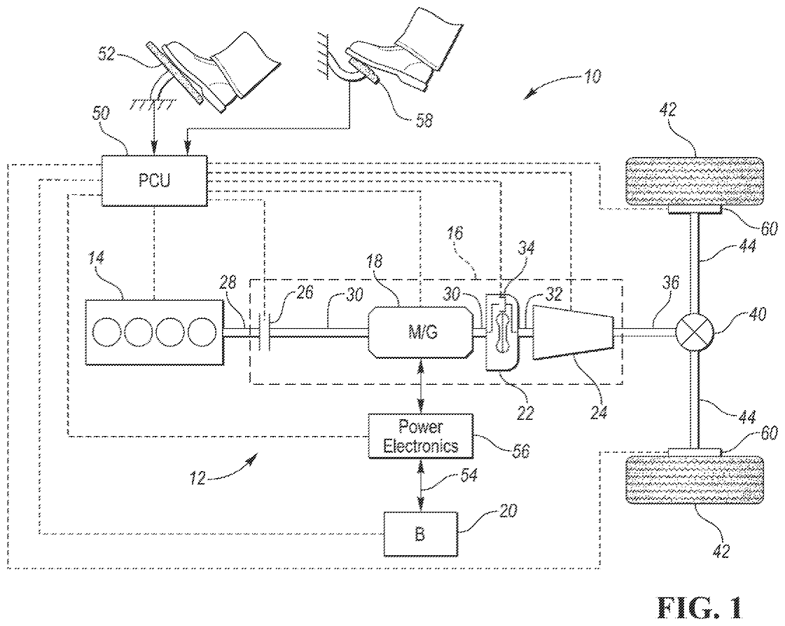

Referring to FIG. 1, a schematic diagram of a hybrid electric vehicle (HEV) 10 is illustrated according to an embodiment of the present disclosure. FIG. 1 illustrates representative relationships among the components. Physical placement and orientation of the components within the vehicle may vary. The HEV 10 includes a powertrain 12. The powertrain 12 includes an engine 14 that drives a transmission 16. As will be described in further detail below, transmission 16 includes an electric machine such as an electric motor/generator (M/G) 18, an associated traction battery 20, a torque converter 22, and a multiple step-ratio automatic transmission, or gearbox 24.

The engine 14 and the M/G 18 are both drive sources for the HEV 10. The engine 14 generally represents a power source that may include an internal combustion engine such as a gasoline, diesel, or natural gas powered engine, or a fuel cell. The engine 14 generates an engine power and corresponding engine torque that is supplied to the M/G 18 when a disconnect clutch 26 between the engine 14 and the M/G 18 is at least partially engaged. The M/G 18 may be implemented by any one of a plurality of types of electric machines. For example, M/G 18 may be a permanent magnet synchronous motor. Power electronics condition direct current (DC) power provided by the battery 20 to the requirements of the M/G 18, as will be described below. For example, power electronics may provide three phase alternating current (AC) to the M/G 18.

When the disconnect clutch 26 is at least partially engaged, power flow from the engine 14 to the M/G 18 or from the M/G 18 to the engine 14 is possible. For example, the disconnect clutch 26 may be engaged and M/G 18 may operate as a generator to convert rotational energy provided by a crankshaft 28 and M/G shaft 30 into electrical energy to be stored in the battery 20. The disconnect clutch 26 can also be disengaged to isolate the engine 14 from the remainder of the powertrain 12 such that the M/G 18 can act as the sole drive source for the HEV 10. Shaft 30 extends through the M/G 18. The M/G 18 is continuously drivably connected to the shaft 30, whereas the engine 14 is drivably connected to the shaft 30 only when the disconnect clutch 26 is at least partially engaged.

The M/G 18 is connected to the torque converter 22 via shaft 30. The torque converter 22 is therefore connected to the engine 14 when the disconnect clutch 26 is at least partially engaged. The torque converter 22 includes an impeller fixed to M/G shaft 30 and a turbine fixed to a transmission input shaft 32. The torque converter 22 thus provides a hydraulic coupling between shaft 30 and transmission input shaft 32. The torque converter 22 transmits power from the impeller to the turbine when the impeller rotates faster than the turbine. The magnitude of the turbine torque and impeller torque generally depend upon the relative speeds. When the ratio of impeller speed to turbine speed is sufficiently high, the turbine torque is a multiple of the impeller torque. A torque converter bypass clutch (also known as a torque converter lock-up clutch) 34 may also be provided that, when engaged, frictionally or mechanically couples the impeller and the turbine of the torque converter 22, permitting more efficient power transfer. The torque converter bypass clutch 34 may be operated as a launch clutch to provide smooth vehicle launch. Alternatively, or in combination, a launch clutch similar to disconnect clutch 26 may be provided between the M/G 18 and gearbox 24 for applications that do not include a torque converter 22 or a torque converter bypass clutch 34. In some applications, disconnect clutch 26 is generally referred to as an upstream clutch and launch clutch 34 (which may be a torque converter bypass clutch) is generally referred to as a downstream clutch.

The gearbox 24 may include gear sets (not shown) that are selectively placed in different gear ratios by selective engagement of friction elements such as clutches and brakes (not shown) to establish the desired multiple discrete or step drive ratios. The friction elements are controllable through a shift schedule that connects and disconnects certain elements of the gear sets to control the ratio between. a transmission output shaft 36 and the transmission input shaft 32. The gearbox 24 is automatically shifted from one ratio to another based on various vehicle and ambient operating conditions by an associated controller, such as a powertrain control unit (PCU). For example, the gearbox 24 may be upshifted from a lower gear to a higher gear (e.g., from 3^{rd} gear to 4^{th} gear) during acceleration or may be downshifted from a higher gear to a lower gear (e.g., from 5^{th} gear to 4^{th} gear) when the vehicle is slowing down. Power and torque from both the engine 14 and the M/G 18 may be delivered to and received by gearbox 24. The gearbox 24 then provides powertrain output power and torque to output shaft 36.

It should be understood that the hydraulically controlled gearbox 24 used with a torque converter 22 is but one example of a gearbox or transmission arrangement; any multiple ratio gearbox that accepts input torque(s) from an engine and/or a motor and then provides torque to an output shaft at the different ratios is acceptable for use with embodiments of the present disclosure. For example, gearbox 24 may be implemented by an automated mechanical (or manual) transmission (AMT) that includes one or more servo motors to translate/rotate shift forks along a shift rail to select a desired gear ratio. As generally understood by those of ordinary skill in the art, an AMT may be used in applications with higher torque requirements, for example.

As shown in the representative embodiment of FIG. 1, the output shaft 36 is connected to a diffrential 40. The differential 40 drives a pair of wheels 42 via respective axles 44 connected to the differential 40. The differential transmits approximately equal torque to each wheel 42 while permitting slight speed differences such as when the vehicle turns a corner. Different types of differentials or similar devices may be used to distribute torque from the powertrain to one or more wheels. In some applications, torque distribution may vary depending on the particular operating mode or condition, for example.

The powertrain 12 further includes an associated controller 50 such as a powertrain control unit (PCU). While illustrated as one controller, the controller 50 may be part of a larger control system and may be controlled by various other controllers throughout the vehicle 10, such as a vehicle system controller (VSC). It should therefore be understood that the powertrain control unit 50 and one or more other controllers can collectively be referred to as a “controller” that controls various actuators in response to signals from various sensors to control functions such as starting/stopping engine 14, operating M/G 18 to provide wheel torque or charge battery 20, select or schedule transmission shifts, etc. Controller 50 may include a microprocessor or central processing unit (CPU) in communication with various types of computer readable storage devices or media. Computer readable storage devices or media may include volatile and nonvolatile storage in read-only memory (ROM), random-access memory (RAM), and keep-alive memory (KAM), for example. KAM is a persistent or non-volatile memory that may be used to store various operating variables while the CPU is powered down. Computer-readable storage devices or media may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller in controlling the engine or vehicle.

The controller communicates with various engine/vehicle sensors and actuators via an input/output (I/O) interface (including input and output channels) that may be implemented as a single integrated interface that provides various raw data or signal conditioning, processing, and/or conversion, short-circuit protection, and the like. Alternatively, one or more dedicated hardware or firmware chips may be used to condition and process particular signals before being supplied to the CPU. As generally illustrated in the representative embodiment of FIG. 1, controller 50 may communicate signals to and/or from engine 14, disconnect clutch 26, M/G 18, battery 20, launch clutch 34, transmission gearbox 24, and power electronics 56. Although not explicitly illustrated, those of ordinary skill in the art will recognize various functions or components that may be controlled by controller 50 within each of the subsystems identified above. Representative examples of parameters, systems, and/or components that may be directly or indirectly actuated using control logic and/or algorithms executed by the controller include fuel injection timing, rate, and duration, throttle valve position, spark plug ignition timing (for spark-ignition engines), intake/exhaust valve timing and duration, front-end accessory drive (FEAD) components such as an alternator, air conditioning compressor, battery charging or discharging (including determining the maximum charge and discharge power limits), regenerative braking, M/G operation, clutch pressures for disconnect clutch 26, launch clutch 34, and transmission gearbox 24, and the like. Sensors communicating input through the I/O interface may be used to indicate turbocharger boost pressure, crankshaft position (PIP), engine rotational speed (RPM), wheel speeds (WS1, WS2), vehicle speed (VSS), coolant temperature (ECT), intake manifold pressure (MAP), accelerator pedal position (PPS), ignition switch position (IGN), throttle valve position (TP), air temperature (TMP), exhaust gas oxygen (EGO) or other exhaust gas component concentration or presence, intake air flow (MAF), transmission gear, ratio, or mode, transmission oil temperature (TOT), transmission turbine speed (TS), torque converter bypass clutch 34 status (TCC), deceleration or shift mode (MDE), battery temperature, voltage, current, or state of charge (SOC) for example.

Control logic or functions performed by controller 50 may be represented by flow charts or similar diagrams in one or more figures. These figures provide representative control strategies and/or logic that may be implemented using one or more processing strategies such as event-driven, interrupt-driven, multi-tasking, multi-threading, and the like. As such, various steps or functions illustrated may be performed in the sequence illustrated, in parallel, or in some cases omitted. Although not always explicitly illustrated, one of ordinary skill in the art will recognize that one or more of the illustrated steps or functions may be repeatedly performed depending upon the particular processing strategy being used. Similarly, the order of processing is not necessarily required to achieve the features and advantages described herein, but is provided for ease of illustration and description. The control logic may be implemented primarily in software executed by a microprocessor-based vehicle, engine, and/or powertrain controller, such as controller 50. Of course, the control logic may be implemented in software, hardware, or a combination of software and hardware in one or more controllers depending upon the particular application. When implemented in software, the control logic may be provided in one or more computer-readable storage devices or media having stored data representing code or instructions executed by a computer to control the vehicle or its subsystems. The computer-readable storage devices or media may include one or more of a number of known physical devices which utilize electric, magnetic, and/or optical storage to keep executable instructions and associated calibration information, operating variables, and the like.

An accelerator pedal 52 is used by the driver of the vehicle to provide a demanded torque, power, or drive command to propel the vehicle. In general, depressing and releasing the accelerator pedal 52 generates an accelerator pedal position signal that may be interpreted by the controller 50 as a demand for increased power or decreased power, respectively. A brake pedal 58 is also used by the driver of the vehicle to provide a demanded braking torque to slow the vehicle. In general, depressing and releasing the brake pedal 58 generates a brake pedal position signal that may be interpreted by the controller 50 as a demand to decrease the vehicle speed. Based upon inputs from the accelerator pedal 52 and brake pedal 58, the controller 50 commands the torque to the engine 14, M/G 18, and friction brakes 60. The controller 50 also controls the timing of gear shifts within the gearbox 24, as well as engagement or disengagement of the disconnect clutch 26 and the torque converter bypass clutch 34. Like the disconnect clutch 26, the torque converter bypass clutch 34 can be modulated across a range between the engaged and disengaged positions. This produces a variable slip in the torque converter 22 in addition to the variable slip produced by the hydrodynamic coupling between the impeller and the turbine. Alternatively, the torque converter bypass clutch 34 may be operated as locked or open without using a modulated operating mode depending on the particular application.

To drive the vehicle with the engine 14, the disconnect clutch 26 is at least partially engaged to transfer at least a portion of the engine torque through the disconnect clutch 26 to the M/G 18, and then from the M/G 18 through the torque converter 22 and gearbox 24. The M/G 18 may assist the engine 14 by providing additional power to turn the shaft 30. This operation mode may be referred to as a “hybrid mode” or an “electric assist mode.”

To drive the vehicle with the M/G 18 as the sole power source, the power flow remains the same except the disconnect clutch 26 isolates the engine 14 from the remainder of the powertrain 12. Combustion in the engine 14 may be disabled or otherwise OFF during this time to conserve fuel. The traction battery 20 transmits stored electrical energy through wiring 54 to power electronics 56 that may include an inverter, for example. The power electronics 56 convert DC voltage from the battery 20 into AC voltage to be used by the M/G 18. The controller 50 commands the power electronics 56 to convert voltage from the battery 20 to an AC voltage provided to the M/G 18 to provide positive or negative torque to the shaft 30. This operation mode may be referred to as an “electric only” or “EV” operation mode.

In any mode of operation, the M/G 18 may act as a motor and provide a driving force for the powertrain 12. Alternatively, the M/G 18 may act as a generator and convert kinetic energy from the powertrain 12 into electric energy to be stored in the battery 20. The M/G 18 may act as a generator while the engine 14 is providing propulsion power for the vehicle 10, for example. The M/G 18 may additionally act as a generator during times of regenerative braking where the M/G 18 is utilized to slow the HEV 10. During regenerative braking torque and rotational energy or power from spinning wheels 42 is transferred back through the gearbox 24, torque converter 22, (and/or torque converter bypass clutch 34) and is converted into electrical energy for storage in the battery 20.

It should be understood that the schematic illustrated in FIG. 1 is merely exemplary and is not intended to be limiting. Other configurations are contemplated that utilize selective engagement of both an engine and a motor to transmit through the transmission. For example, the M/G 18 may be offset from the crankshaft 28, an additional motor may be provided to start the engine 14, and/or the M/G 18 may be provided between the torque converter 22 and the gearbox 24. Other configurations are contemplated without deviating from the scope of the present disclosure.

It should be understood that the vehicle configuration described herein is merely exemplary and is not intended to be limited. Other electric or hybrid vehicle configurations should be construed as disclosed herein. Other vehicle configurations may include, but are not limited to, series hybrid vehicles, parallel hybrid vehicles, series-parallel hybrid vehicles, plug-in hybrid electric vehicles (PHEVs), fuel cell hybrid vehicles, battery operated electric vehicles (BEVs), or any other electric or hybrid vehicle configuration known to a person of ordinary skill in the art.

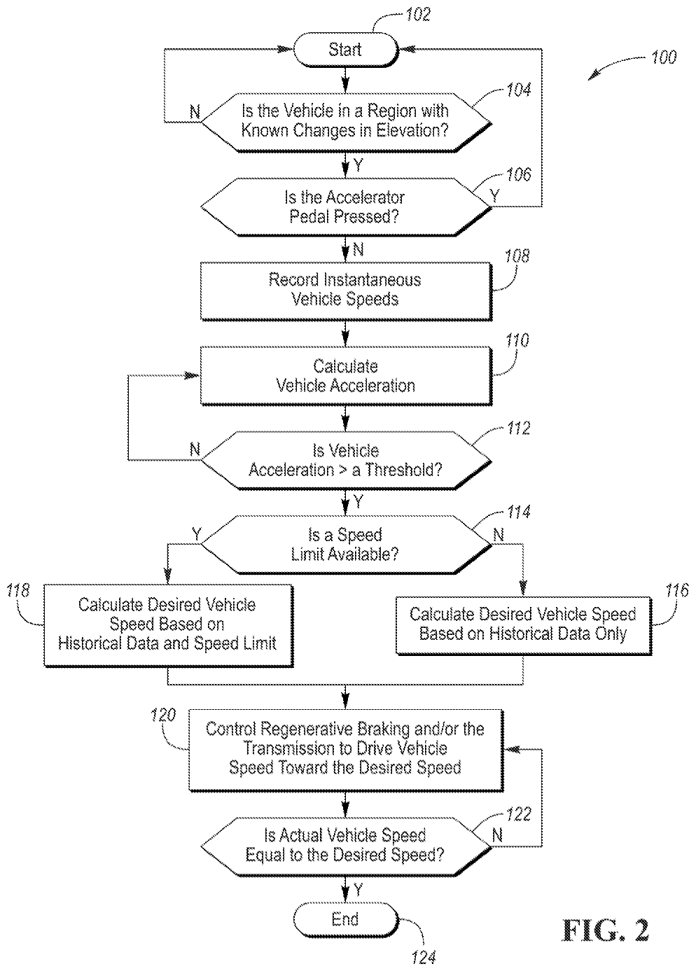

Referring to FIG. 2, a flowchart of a method 100 of controlling an automatic transmission (e.g., gearbox 24) and regenerative braking in a hybrid or electric vehicle (e.g., HEV 10) during a hill descent is illustrated. The method 100 may be stored as control logic and/or an algorithm within the controller 50. The controller 50 may implement the method 100 by controlling the various components of the HEV 10. The method 100 is initiated at start block 102. The method 100 may be initiated by turning on the ignition of the HEV 10. Once the method 100 has been initiated, the method 100 moves on to block 104 where it is determined if the vehicle is in a region with known changes in elevation where extended periods of downhill driving may be expected. The HEV 10 may include a global positioning system (GPS) that includes a database of roadmaps. The database of the GPS may also include data regarding the upgrade or downgrade along the various positions on the roadmaps within the database. If the HEV 10 is not in a region with known changes in elevation where extended periods of downhill driving may be expected, the method 100 recycles back to start block 102. If the HEV 10 is in a region with known changes in elevation where extended periods of downhill driving may be expected, the method 100 moves onto block 106. It should be noted that the step of block 104 is optional. For example, the method 100 may move directly from start block 102 to block 106. However, including the step of block 104 may increase the robustness against false positives for identifying a hill descent.

At block 106, it is determined whether or not the accelerator pedal 52 is being pressed. If the HEV 10 is an autonomous vehicle, the step at block 106 may determine whether or not a virtual accelerator pedal position is being commanded by the controller 50. If the accelerator pedal 52 is being pressed, the method 100 recycles back to start block 102. If the accelerator pedal 52 is not being pressed, the method 100 moves on to block 108. Alternatively, at block 106 the method 100 may determine if the accelerator pedal 52 has been released after being depressed. If the accelerator pedal 52 continues to be depressed and has not been released, the method 100 recycles back to start block 102. On the other hand, if the accelerator pedal 52 is released after being depressed, the method 100 moves onto block 108. It should be noted, that depression or engagement of the accelerator pedal 52 may also function as a reset that returns the method 100 to start block 102, regardless of which step or block the method 100 is currently implementing. This is to prevent the method 100 from hindering vehicle acceleration when it is desired. If vehicle acceleration is desired, which is indicated by the accelerator pedal 52 remaining depressed or engaged, the speed of the HEV 10 may be controlled by adjusting the speed, torque, and/or power output of the M/G 18 and/or engine 14 in order to drive the speed of the vehicle to a speed that is based on position of the accelerator pedal 52.

At block 108 the method 100 begins to record instantaneous vehicle speeds. The instantaneous vehicle speeds may be recorded using a rolling buffer. The rolling buffer may be calibrated to a set time or a set number of samples of vehicle speeds. When the maximum time or the maximum number of samples has been obtained, the method 100 will remove the first chronologically stored sample and store the most recently recorded sample. If the accelerator pedal 52 is depressed at any time while the method 100 is recording instantaneous vehicle speeds at block 108, the rolling buffer may be reset and cleared of all recorded instantaneous vehicle speeds.

The method 100 then moves on to block 110 where the acceleration of the HEV 10 is calculated. The acceleration of the HEV 10 may an instantaneous acceleration that is calculated based on the two most recently recorded samples of vehicles speeds within the rolling buffer at block 108. More specifically, the acceleration of the HEV 10 may be the difference between the two most recently recorded samples of vehicle speeds divided by the time span between when each sample was recorded. Block 110 may operate simultaneously with block 108 allowing the instantaneous calculated vehicle acceleration to be updated as new samples of vehicle speeds are recorded via the rolling buffer at block 108.

The method 100 then determines at block 112 if the vehicle acceleration exceeds a threshold or calibrated value. If the vehicle acceleration does not exceed the threshold or calibrated value, the method 100 recycles back to block 110, it should be noted that block 112 may also operate simultaneously with block 108 and block 110. If the vehicle acceleration does exceed the threshold or calibrated value at block 112, it is determined that the HEV 10 is on a hill descent and the method 100 moves onto block 114. Block 112 may require the vehicle acceleration to exceed the threshold or calibrated value for two or more consecutive instantaneous calculated vehicle accelerations (which updates as the recorded vehicle speeds recorded in rolling buffer are updated) in order verify that the HEV 10 is on a hill descent in order for the method 100 to move on to block 114.

At block 114, the method 100 determines if a local speed limit is available. The speed limit may be based on stored values at specific locations within the GPS, maybe based on a most recent reading of a roadway speed limit sign that was recorded via a camera that is mounted to the HEV 10, or maybe based on a set point of a cruise control system of the HEV 10 (i.e., a desired speed set by the vehicle operator via the cruise control system). If a local speed limit is not available, the method 100 moves onto block 116 where a desired speed of the HEV 10 is calculated based on historical data only. For example, the desired speed of the HEV 10 may be based on an initial or first vehicle speed that corresponds with a speed of the HEV 10 that was recorded at the time the accelerator pedal 52 was released at block 106 or at a first instantaneous vehicle speed recorded via the rolling buffer at block 108, which occurred after releasing the accelerator pedal 52 but prior to recording and/or detecting any acceleration of the HEV 10. If a local speed limit is available, the method 100 moves onto block 118 where a desired speed of the HEV 10 is calculated based on the historical data and the speed limit. For example, a weighted average between the speed limit and the initial or first vehicle speed that corresponds with the speed of the HEV 10 that was recorded at the time the accelerator pedal 52 was released at block 106 may be utilized to calculate the desired vehicle speed.

Once the desired speed of the HEV 10 is calculated at either block 116 or block 118, the method moves onto block 120 where regenerative braking and/or the transmission (e.g., gearbox 24) are controlled to drive the speed of the HEV 10 toward the desired speed. More specifically, the torque, speed, or power output of the M/G 18 may be adjusted and/or the gear (e.g., 1^{st}, 2^{nd}, 3^{rd}, 4^{th}, etc.) that the gearbox 24 is in may be shifted to drive the speed of the HEV 10 toward the desired speed. The method 100 then moves on to block 122 where it is determined if the actual vehicle speed is equal to the desired speed. The actual vehicle speed may be a measured vehicle speed. For example, the actual vehicle speed may be derived from measuring the rotational speed of the wheels 42. Rotational speed of the wheels 42 may be converted to linear speed of the HEV 10 based on the radius of the wheels 42, since linear speed is equal to angular speed (in radians/s) multiplied by the radius of the wheels 42. If the vehicle speed is not equal to the desired speed, the method 100 recycles back to block 120. Is the vehicle speed is equal. to the desired speed, the method 100 ends at block 124. Block 122 may operate simultaneously with block 120 allowing the method 100 to adjust regenerative braking and/or the transmission to drive the speed of the HEV 10 toward the desired speed while also checking to see if the actual vehicle speed is equal to the desired vehicle speed.

Alternatively, at block 124 the method 100 may continue to control regenerative braking and/or the transmission according to the process outlined in block 120 in order to maintain the actual vehicle speed at the desired vehicle speed (i.e., to ensure actual vehicle speed is equal to desired vehicle speed). If the accelerator pedal 52 is subsequently depressed or engaged alter the release of the accelerator pedal 52 that resulted in controlling regenerative braking and/or the transmission to drive the speed of the HEV 10 toward the desired speed at block 120, the method 100 may suspend regenerative braking (or more specifically may suspend operation of the M/G 18 to produce braking torque) and may suspend controlling the transmission (or more specifically may suspend shifting the gearbox 24) to drive the speed of the HEV 10 toward the desired speed calculated in either block 116 or block 118. Also, in response to such a subsequent or next depression or engagement of the accelerator pedal 52, the speed of the HEV 10 may be controlled by adjusting the speed, torque, and/or power output of the M/G 18 and/or engine 14 in order to drive the speed of the vehicle to an updated desired speed that is based on the position of the accelerator pedal 52. It should be understood that the flowchart in FIG. 2 is for illustrative purposes only and that the method 100 should not be construed as limited to the flowchart in FIG. 2. Some of the steps of the method 100 may be rearranged while others may be omitted entirely.

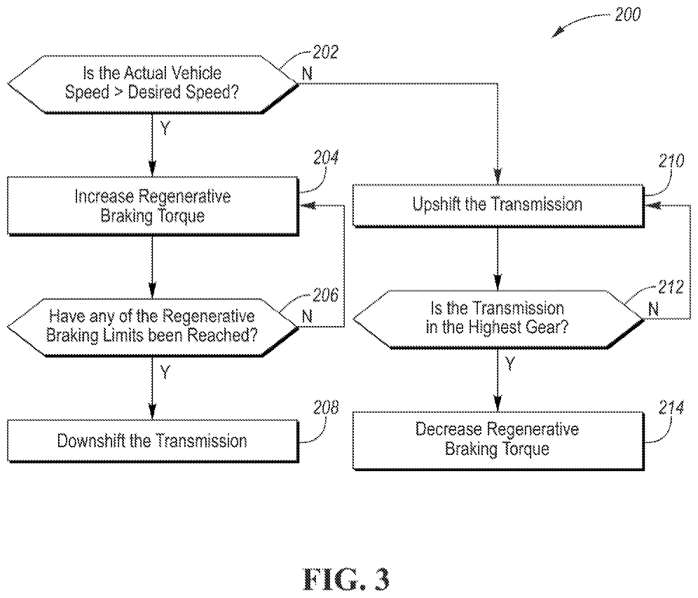

Referring to FIG. 3, a flowchart of a method 200 of further controlling the automatic transmission (e.g., gearbox 24) and regenerative braking in a hybrid or electric vehicle (e.g., HEV 10) during a hill descent is illustrated. More specifically, method 200 may represent the adjustments to the M/G 18 and/or gearbox 24 that are implemented in block 120 of method 100 in order to drive the speed of the HEV 10 toward the desired speed. The method 200 may also be stored as control logic and/or an algorithm within the controller 50. The controller 50 may implement the method 200 by controlling the various components of the HEV 10.

The method 200 includes two paths for adjusting the speed of the HEV 10 order to drive the speed of the HEV 10 toward the desired speed. The first path which includes block 204, block 206, and block 208, is designed to lower the speed of the HEV 10 in order to drive the speed of the HEV 10 toward the desired speed by first increasing the regenerative braking torque of the M/G 18 followed by downshifting the transmission (i.e., gearbox 24) if necessary. The second path, which includes block 210, block 112, and block 214, is designed to increase vehicle speed in order to drive the speed of the HEV 10 toward the desired speed by first decreasing the regenerative braking torque of the M/G 18 followed by upshifting the transmission (i.e., gearbox 24) if necessary. The second path may be utilized in the event the upgrade or slope of the road decreases while the method 200 is operating along the first path or in the event that the vehicle speed overshoots the desired speed (i.e., is reduced to less than the desired speed) due to overaggressive regenerative braking and/or downshifting.

First, the method 200 determines if the actual vehicle speed is greater than the desired vehicle speed at block 202. If the actual speed of the HEV 10 is greater than the desired vehicle speed, the method 200 moves on to block 204 where the regenerative torque of the M/G 18 is increased to decrease the speed of the HEV 10 and to drive the actual speed of the HEV 10 toward the desired speed. Increases in regenerative braking torque may be in predetermined step sizes that may be calibrated based on specific attributes of the vehicle such as weight, rolling resistance, drivability etc.

Next, the method 200 moves on to block 206 where it is determined if any of the regenerative braking limits have been reached. Regenerative braking limits may include a maximum torque of the M/G 18, an upper limit of a state of charge of the battery 20, a power limit of inverting circuitry within the power electronics 56, etc. If none of the regenerative braking limits have been reached, the method recycles back to block 204. If the speed of the vehicle has reached the desired speed or deviates to a value that is slightly greater than the desired speed, the method 200 may continue to increase or adjust regenerative braking of the M/G 18 without shifting the transmission (i.e., gearbox 24) according to block 204 in order to maintain the speed of the HEV 10 at the desired speed or to drive the actual speed of the HEV 10 toward the desired speed as long as the regenerative braking limits have been not been reached.

If one or more of the regenerative braking limits (e.g., the maximum torque of the M/G 18, the upper limit of the state of charge of the battery 20, the power limit of inverting circuitry, etc.) have been reached and the actual speed of the HEV 10 is still greater than the desired speed, the method 200 moves on to block 208 where the transmission gearbox 24) is downshifted in order to decrease the speed of the HEV 10 and to drive the actual speed of the HEV 10 toward the desired speed. If the actual speed of the HEV 10 and the desired speed become equal at block 208, the method 200 may maintain the current gear of the transmission. The downshifting of the transmission that may occur at block 208 may be limited by speed requirements for operating the HEV 10 in the specific gear. For example, if the method 200 is requesting another downshift of the transmission in order to drive the actual speed of the HEV 10 to the desired speed but such a downshift would result in the actual vehicle speed being greater than an upper limit for the gear the transmission is to be downshifted into, then the method 200 will not allow the downshift to occur.

Returning to block 202, if the actual speed of the HEV 10 is less than the desired vehicle speed, the method 200 moves on to block 210 where the transmission (i.e., gearbox 24) is upshifted to increase the speed of the HEV 10 and to and to drive the actual speed of the HEV 10 toward the desired speed. The actual speed of the HEV 10 decreasing to less than the desired speed may have been the result of an increase in regenerative braking torque at block 204 that overshot the desired speed. The method 200 may be limited at block 210 by the lugging limits of the engine 14. For example, if an upshift in the transmission would violate the lugging limits, the method 200 may assume that the transmission is in the highest possible gear for the current conditions such that the transmission may no longer be upshifted. Next, the method moves on to block 212 where it is determined if the transmission is in the highest gear or in the highest possible gear for the current conditions. If the transmission is not in the highest gear or in the highest possible gear for the conditions, the method 212 recycles back to block 210 wherein the transmission is further upshifted to increase the speed of the HEV 10 and to and to drive the actual speed of the HEV 10 toward the desired speed. If the transmission is in the highest gear or in the highest possible gear for the conditions, the method 200 moves on to block 214 where the regenerative braking torque of the M/G 18 is decreased to increase the speed of the HEV 10 and to and to drive the actual speed of the HEV 10 toward the desired speed. Decreases in regenerative braking torque may be in predetermined step sizes that may be calibrated based on specific attributes of the vehicle such as weight, rolling resistance, drivability etc. It should be understood that the flowchart in FIG. 3 is for illustrative purposes only and that the method 200 should not be construed as limited to the flowchart in FIG. 3. Some of the steps of the method 200 may be rearranged while others may be omitted entirely.

The words used in the specification are words of description rather than limitation, and it is understood that various changes may be made without departing from the spirit and scope of the disclosure. As previously described, the features of various embodiments may be combined to form further embodiments that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. As such, embodiments described as less desirable than other embodiments or prior art implementations with respect to one or more characteristics are not outside the scope of the disclosure and may be desirable for particular applications.

What is claimed is:

1. A vehicle comprising:
an electric machine configured to recharge a battery and to slow the vehicle via regenerative braking;
an automatic transmission disposed between the electric machine and at least one drive wheel and configured to shift between a plurality of gears; and
a controller programmed to,
in response to release of an accelerator pedal at a first vehicle speed and a subsequent increase in vehicle speed while the accelerator pedal is released, increase a regenerative braking torque to decrease vehicle speed and drive vehicle speed toward a desired vehicle speed,
in response to vehicle speed decreasing to the desired vehicle speed via regenerative braking after the subsequent increase in vehicle speed, control regenerative braking torque to maintain vehicle speed at the desired vehicle speed,
in response to regenerative braking torque reaching a maximum value and vehicle speed being greater than the desired vehicle speed after the subsequent increase in vehicle speed, downshift the transmission to decrease vehicle speed and drive vehicle speed toward the desired speed,
in response to a state of charge of the battery exceeding a limit and vehicle speed being greater than the desired vehicle speed after the subsequent increase in vehicle speed, downshift the transmission to decrease vehicle speed and drive vehicle speed toward the desired speed,
in response to a next engagement of the accelerator pedal after the release of the accelerator pedal, suspend regenerative braking torque and control vehicle speed based on a position of the accelerator pedal.

2. The vehicle of claim 1, wherein the desired vehicle speed is equal to the first vehicle speed.

3. The vehicle of claim 1, wherein the desired vehicle speed is based on a weighted average between the first vehicle speed and a roadway speed limit.

4. The vehicle of claim 1, wherein the controller is configured to drive vehicle speed toward the first vehicle speed after the subsequent increase in vehicle speed in response to vehicle acceleration exceeding a threshold.

5. A vehicle comprising:
an electric machine configured to slow the vehicle via regenerative braking; and
a controller programmed to,
in response to release of an accelerator pedal at a first vehicle speed and a subsequent increase in vehicle speed while the accelerator pedal is released, increase a regenerative braking torque to decrease vehicle speed and drive vehicle speed toward a desired vehicle speed, and
in response to a next engagement of the accelerator pedal after the release of the accelerator pedal, suspend regenerative braking torque and control vehicle speed based on a position of the accelerator pedal.

6. The vehicle of claim 5, wherein the controller is further programmed to, in response to vehicle speed decreasing to the desired vehicle speed via regenerative braking after the subsequent increase in vehicle speed, control regenerative braking torque to maintain vehicle speed at the desired vehicle speed.

7. The vehicle of claim 5 further comprising an automatic transmission that is configured to transfer power between the electric machine and at least one drive wheel, wherein the controller is further programmed to, in response to regenerative braking torque reaching a maximum value and vehicle speed being greater than the desired vehicle speed after the subsequent increase in vehicle speed, downshift the transmission to decrease vehicle speed and drive vehicle speed toward the desired vehicle speed.

8. The vehicle of claim 5 further comprising a battery, wherein the electric machine is configured to recharge a battery during regenerative braking and, wherein the controller is further programmed to, in response to a state of charge of the battery exceeding a limit and vehicle speed being greater than the desired vehicle speed after the subsequent increase in vehicle speed, downshift the transmission to decrease vehicle speed and drive vehicle speed toward the desired vehicle speed.

9. The vehicle of claim 5, wherein the desired vehicle speed is equal to the first vehicle speed.

10. The vehicle of claim 5, wherein the desired vehicle speed is based on a weighted average between the first vehicle speed and a roadway speed limit.

11. The vehicle of claim 5, wherein the controller is configured to drive vehicle speed toward the desired vehicle speed after the subsequent increase in vehicle speed in response to vehicle acceleration exceeding a threshold.

12. The vehicle of claim 5 further comprising an automatic transmission that is configured to transfer power between the electric machine and at least one drive wheel, wherein the controller is further programmed to, in response to vehicle speed decreasing to less than the desired vehicle speed via regenerative braking after the subsequent increase in vehicle speed, upshift the transmission to increase vehicle speed and drive vehicle speed toward the desired vehicle speed.

13. The vehicle of claim 12, wherein the controller is further programmed to, in response to vehicle speed decreasing to less than the desired vehicle speed via regenerative braking after the subsequent increase in vehicle speed while the transmission is in the highest gear, decrease regenerative braking torque.

14. A regenerative braking control method for a vehicle comprising:
releasing an accelerator pedal at a desired vehicle speed;
detecting a subsequent increase in vehicle speed from the desired vehicle speed while the accelerator pedal is released;
in response to detecting the subsequent increase in vehicle speed, increasing, a regenerative braking torque to decrease vehicle speed and drive vehicle speed toward the desired vehicle speed; and
in response to a next engagement of the accelerator pedal after the releasing the accelerator pedal, suspending regenerative braking torque and controlling vehicle speed based on a position of the accelerator pedal.

15. The method of claim 14 further comprising, in response to vehicle speed decreasing to the desired vehicle speed via regenerative braking after the subsequent increase in vehicle speed, controlling regenerative braking torque to maintain vehicle speed at the desired vehicle speed.

16. The method of claim 14 further comprising, in response to regenerative braking torque reaching a maximum value and vehicle speed being greater than the desired vehicle speed after the subsequent increase in vehicle speed, downshifting a transmission to decrease vehicle speed and drive vehicle speed toward the desired vehicle speed.

17. The method of claim 14 further comprising, in response to a state of charge of a battery exceeding a limit and vehicle speed being greater than the desired vehicle speed after the subsequent increase in vehicle speed, downshifting a transmission to decrease vehicle speed and drive vehicle speed toward the desired vehicle speed.

18. The method of claim. 14, wherein detecting the subsequent increase in vehicle speed corresponds with vehicle acceleration exceeding a threshold.

19. The method of claim 14 further comprising, in response to vehicle speed decreasing to less than the desired vehicle speed via regenerative braking after the subsequent increase in vehicle speed, upshifting a transmission to increase vehicle speed and drive vehicle speed toward the desired vehicle speed.

20. The method of claim 14 further comprising, in response to vehicle speed decreasing to less than the desired vehicle speed via regenerative braking after the subsequent increase in vehicle speed while a transmission is in the highest gear, decreasing regenerative braking torque.
